(19) United States
(12) Patent Application Publication
(10) Pub. No.: US 2005/0233202 A1
(43) Pub. Date: Oct. 20, 2005

(54) Thermoplastic-imbibed diffusion media to help eliminate MEA edge failure

(76) Inventors: Matthew M. Fay, Rochester, NY (US); Bhaskar Sompalli, Rochester, NY (US)

Correspondence Address: CARY W. BROOKS;Gereral Motors Corporation, Legal Staff, Mail Code 482-C23-B21, P.O. Box 300, Detroit, MI, 48265-3000, US

(21) Appl. No.: 10/827,731

(22) Filed: Apr. 20, 2004

(51) Int. Cl. H01M 4/94; H01M 4/88; B05D 5/12

(52) U.S. Cl. 429/44; 429/42; 427/115; 502/101

(57) ABSTRACT

A fuel cell that includes a blocking agent for preventing hydrogen and air from contacting bare membrane. This in turn prevents the reaction of air and hydrogen gases at outside edges of the catalyst layers. The blocking agent is deposited within diffusion media layers on one or both of the anode and cathode sides of the fuel cell. The blocking agent extends into the diffusion media layers far enough so that it is within outside edges of the catalyst layers. In one embodiment, the blocking agent is a thermoplastic polymer, such as PVDF, that flows into the diffusion media layers in a melted format, where it hardens.

### BACKGROUND OF THE INVENTION

1. Field of the Invention

This invention relates generally to a fuel cell and, more particularly, to a fuel cell including diffusion media layers having selectively positioned blocking agents that prevent hydrogen gas and oxygen gas from combining and reacting at outside edges of the catalyst layers that might otherwise cause membrane failure.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated at the anode, with the aid of a catalyst, to generate free hydrogen protons and electrons. The hydrogen protons pass through the electrolyte to the cathode. The hydrogen protons react with the oxygen and the electrons at the cathode, with the aid of a catalyst, to generate water. The electrons from the anode cannot pass through the electrolyte, and thus are directed through a load to perform work before arriving at the cathode. The work acts to operate the vehicle.

Proton exchange membrane fuel cells (PEMFC) are a popular fuel cell for vehicles. The PEMFC generally includes a solid polymer electrolyte proton conducting membrane, such as a perfluorinated acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. For example, a typical fuel cell stack for a vehicle may have two hundred stacked fuel cells. The fuel cell stack receives a cathode input gas, such as air, typically forced through the stack by a compressor. Not all of the oxygen in the air is consumed by the stack and some of the air is output as a cathode exhaust gas that may include water as a stack by-product. The fuel cell stack also receives an anode hydrogen input gas that flows into the anode side of the stack.

FIG. 1 is a cross-sectional view of a fuel cell 10 of the type discussed above. The fuel cell 10 includes a cathode side 12 and an anode side 14 separated by an electrolyte membrane 16. A cathode diffusion media layer 20 is provided at the cathode side 12, and a cathode catalyst layer 22 is provided between membrane 16 and the diffusion media layer 20. Likewise, an anode diffusion media layer 24 is provided at the anode side 14, and an anode catalyst layer 26 is provided between the diffusion media layer 24 and the membrane 16. The catalysts layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 22 and 24, respectively, or on the proper side of the membrane 16.

A bipolar plate 18 including flow fields provides an airflow 36 for the cathode side 12 and an opposing bipolar plate 30 including flow fields provides a hydrogen gas flow 28 for the anode side 14. The bipolar plates 18 and 30 separate the fuel cells in a fuel cell stack, as is well known in the art. As discussed above, the hydrogen gas flow 28 reacts with the catalyst in the catalyst layer 26 to dissociate the hydrogen ions and the electrons. The hydrogen ions are able to propagate through the membrane 16 where they electrochemically react with the airflow 36 and the return electrons in the catalyst layer 22 to generate water.

Fuel cells must have a certain durability to be viable in an automotive application or otherwise. It has been observed that the membrane 16 sometimes prematurely fails adjacent to an outside edge 32 and 34 of the catalyst layers 22 and 26, respectively, thus reducing the fuel cell's durability and longevity. It is known that the membrane 16 does not possess infinite resistance to gas permeation. It is believed that one or both of the hydrogen gas flow 28 and/or the airflow 36 crosses the membrane 16 outside of the catalyst layer edges 32 and 34, and reacts with the other hydrogen gas flow 28 or airflow 36 at the catalyst layer edges 32 and 34. The outside edges 32 and 34 of the catalyst layers 22 and 26 are the first location that the mixture of gases encounters the catalyst.

This overall reaction is the same reaction as the sum of the half-reactions that occur at the catalyst layers 22 and 26; however, none of the energy of this reaction from the gas crossover operates to move electrons through an external circuit. This excess energy manifests itself in the form of heat production. In other words, because it is the air and hydrogen gases that react spontaneously at the outside edges 32 and 34 of the catalyst layers 22 and 26 instead of the oxygen and hydrogen ions, none of the energy produced by the reaction is captured by the external circuit. All the energy that is generated by the gas reaction is converted to heat, which causes a premature failure of the membrane 16 adjacent to the catalyst layer edges 32 and 34. If the airflow 36 crosses the membrane 16, H₂O₂ is formed, which can also chemically degrade the membrane 16.

### SUMMARY OF THE INVENTION

In accordance with the teachings of the present invention, a fuel cell is disclosed that includes a blocking agent for preventing hydrogen and air from contacting bare membrane. This in turn prevents the reaction of air and hydrogen gases at outside edges of the catalyst layers. The blocking agent is deposited within diffusion media layers on one or both of the anode and cathode sides of the fuel cell. The blocking agent extends into the diffusion media layers far enough so that it is within outside edges of the catalyst layers. In one embodiment, the blocking agent is a thermoplastic polymer, such as PVDF, that flows into the diffusion media layers in a melted format, where it hardens.

Additional advantages and features of the present invention will become apparent from the following description and appended claims, taken in conjunction with the accompanying drawings.

### BRIEF DESCRIPTION OF THE DRAWINGS

FIG. 1 is a cross-sectional view of a known fuel cell;

FIG. 2 is a cross-sectional view of a fuel cell employing blocking agents in diffusion media layers, according to an embodiment of the present invention; and

FIG. 3 is a graph with run time on the horizontal axis and cell voltage on the vertical axis showing the relationship between cell voltage and run time for a known fuel cell and a fuel cell employing a blocking agent of the invention.

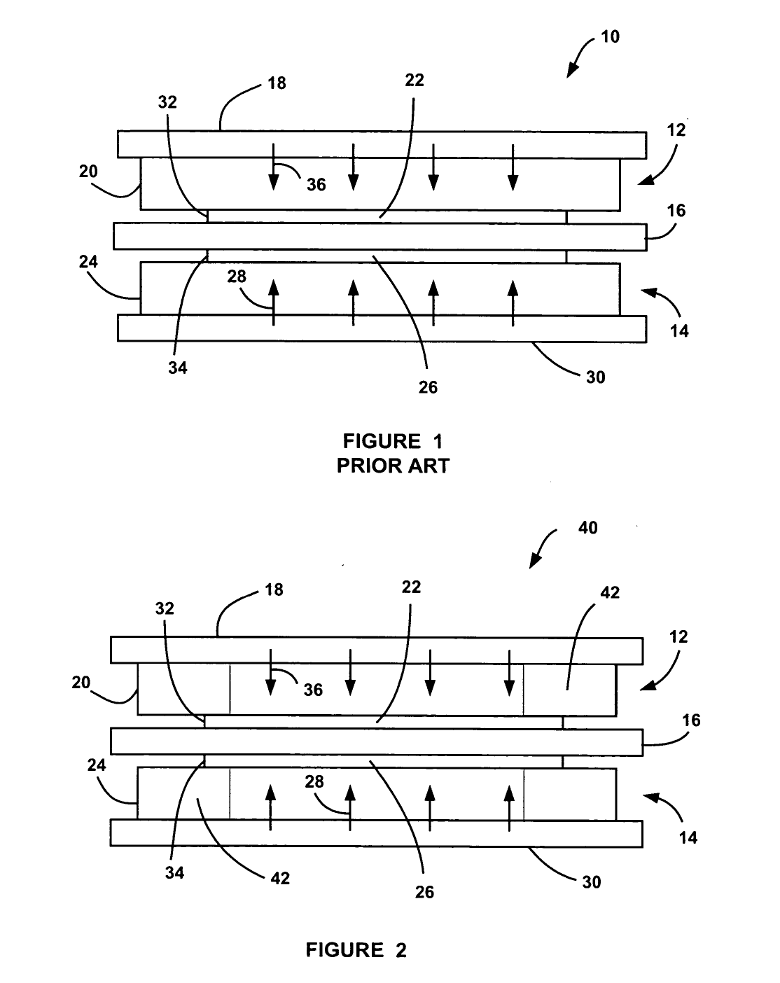

### DETAILED DESCRIPTION OF THE EMBODIMENTS

The following description of the embodiments of the invention directed to a fuel cell employing hydrogen and air blocking agents is merely exemplary in nature, and is in no way intended to limit the invention or its applications or uses.

FIG. 2 is a cross-sectional view of a fuel cell 40 similar to the fuel cell 10, where like reference numerals identify like elements. According to an embodiment of the present invention, the diffusion media layers 20 and 24 include a blocking agent 42 that extends from the ends of the diffusion media layers 20 and 24 to a location some suitable distance within the edges 32 and 34 of the catalyst layers 22 and 26, respectively. The blocking agent 42 can be any suitable material formed within the diffusion media layers 20 and 24 that acts to block or restrict one or both of the airflow 36 and the hydrogen gas flow 28 from propagating through the membrane 16 outside of the catalyst layers 22 and 26. In other words, the blocking agent 42 forces the airflow 36 and the hydrogen gas flow 28 to enter the catalyst layers 22 and 26, respectively, before the membrane 16. Therefore, the blocking agent 42 prevents the airflow 36 and the hydrogen gas flow 28 from passing to the membrane 16 without first passing through the catalyst layers 22 and 26.

Since gas that reaches the catalyst layers 22 and 26 react, no gas reaches the membrane 16, and no gas passes through the membrane 16. This prevents uncontrolled reaction of hydrogen and oxygen gas at the outside edges 32 and 34, which in turn prevents the membrane 16 from failing adjacent to the outside edges 32 and 34 of the catalyst layers 22 and 26.

In this embodiment, the blocking agent 42 is provided through the entire thickness of the diffusion media layers 20 and 24. This is by way of a non-limiting example in that the blocking agent 42 can be selectively formed within the diffusion media layers 20 and 24 so that it only goes through a portion of the thickness of the diffusion media layers 20 and 24, preferably nearest to the membrane 16.

Also, in this embodiment, the blocking agent 42 is provided in both of the diffusion media layers 20 and 24. It is not particularly clear if premature failure is caused by one or both of the airflow 36 or the hydrogen gas flow 28 that propagates through the membrane 16. Therefore, the blocking agent 42 may only be necessary in one of the diffusion media layers 20 and 24, such as the anode diffusion media layer 24.

The blocking agent 42 does not necessarily have to be resistant to diffusion of the flows 36 and 28. Even if the gas diffusion of the blocking agent 42 is not negligible, the thickness of the diffusion media layers 20 and 24 should be sufficient to force the flows 36 and 28 towards the region of the diffusion media layers 20 and 24 adjacent to the catalyst layers 22 and 26, respectively. This is because the blocking agent 42 need only fill the pores of the diffusion media layers 20 and 24 to increase the gas diffusion length of the flows 36 and 28.

The blocking agent 42 can be any blocking agent suitable for the purposes described herein. For example, the blocking agent 42 can be a thermoplastic polymer, such as polyaryl (ether ketone) or polyethylene. In one embodiment, the blocking agent 42 is polyvinylidene fluoride (PVDF). PVDF provides a good blocking agent because its melting temperature is approximately 170° C., which is above the operating temperature of the fuel cell 40, yet it is not so hot to be difficult to be melted by standard processes and forced into the diffusion media layers 20 and 24. PVDF is also chemically stable in acidic environments, such as in fuel cells.

The following description provides one technique for introducing the PVDF into the diffusion media layers 20 and 24. In one embodiment, a standard Toray 060 diffusion media (7% PTFE added) with dimensions of 73 mm² was used. Two pieces of 0.003 inch thick Kynar® PVDF were cut into frames having outer dimensions of 74 mm² and inner dimensions of 66 mm by 67 mm. The frames were centered on both sides of the diffusion media layers 20 and 24 so that there was equal overlap of the PVDF frames on all sides. The PVDF-DM-PVDF sandwich was placed between two pieces of Kapton® brand polyimide film and two pieces of Gylon® brand PTFE. The entire layer structure was placed between two aluminum plates and hot pressed at 0.1 tons for ten minutes at 350° F. and then at 0.5 tons for ten minutes at 350° F. After hot pressing, the material was removed and investigated. The PVDF was fully imbibed, or consistent throughout the diffusion media layer.

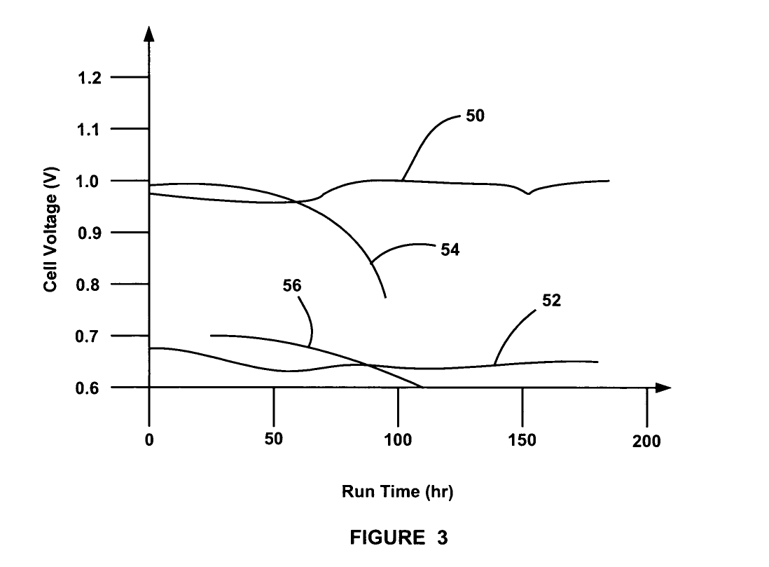

The modified diffusion media layers 20 and 24 with the blocking agent 42 were then placed in a 50 cm² fuel cell to test their effectiveness. FIG. 3 is a graph with run time on the horizontal axis and fuel cell voltage on the vertical axis showing the test results. The fuel cell containing the modified diffusion media layers 20 and 24 including the blocking agent 42 are represented by graph lines 50 and 52. A base line fuel cell containing the same type of MEA and non-modified standard diffusion media layers are represented by graph lines 54 and 56. The graph lines 50 and 54 represent data taken with no current drawn from the fuel cell, and the graph lines 52 and 56 represent data taken with a normalized current of 0.8 A/cm² drawn from the fuel cell. Both fuel cells were run at 95° C. and 200 kPa pressure with a relative humidity of 75% at the anode inlet and 50% at the cathode inlet. The graph lines 54 and 56 indicate that the voltage decreased rapidly and failure occurred in the baseline fuel cell after approximately 100 hours. When the fuel cell was disassembled, significant edge failure was observed.

The fuel cell using the PVDF imbibed diffusion media layer was run out to approximately 175 hours with a much less dramatic cell voltage loss. Additionally, ex-situ shorting current and gas crossover currents were measured and are presented in Table I below. The crossover current did not increase significantly during the run time of the fuel cell. If the MEA was seriously degraded, an increase in the crossover current would be expected. When the fuel cell was disassembled, there was no indication of catalyst layer edge failure. The majority of the failures occurred in the active region of the MEA.

TABLE I

| Run | Shorting | Crossover | Crossover current with ΔP |
|---|---|---|---|
| Time (hr) | current (A) | current (A) | (anode-cathode) of 3 psi (A) |
| 0 | 0.011 | 0.018 | 0.024 |
| 70 | 0.026 | 0.036 | 0.044 |
| 112 | 0.022 | 0.031 | 0.046 |
| 173 | 0.028 | 0.030 | 0.062 |

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A fuel cell comprising:
an anode side including an anode diffusion media layer and an anode catalyst layer;
a cathode side including a cathode diffusion media layer and a cathode catalyst layer; and
a membrane positioned between and in contact with the anode catalyst layer and the cathode catalyst layer, wherein one or both of the diffusion media layers include a blocking agent that prevents or restricts gases that flow through the diffusion media layers from flowing to the membrane without first flowing through the catalyst layers.

2. The fuel cell according to claim 1 wherein the blocking agent is formed within side edges of one or both of the diffusion media layers a distance so that the blocking agent extends within outside edges of the catalyst layers.

3. The fuel cell according to claim 1 wherein the blocking agent is provided through the entire thickness of one or both of the diffusion media layers.

4. The fuel cell according to claim 1 wherein the blocking agent is only provided through a portion of the thickness of one or both of the diffusion media layers.

5. The fuel cell according to claim 1 wherein the blocking agent is uniformly dispersed throughout one or both of the diffusion media layers.

6. The fuel cell according to claim 1 wherein the blocking agent is a thermoplastic polymer.

7. The fuel cell according to claim 6 wherein the blocking agent is selected from the group consisting of polyvinylidene fluoride, polyaryl and polyethylene.

8. The fuel cell according to claim 1 wherein the fuel cell is part of a fuel cell stack.

9. The fuel cell according to claim 8 where the fuel cell stack is on a vehicle.

10. A fuel cell comprising:
an anode side including an anode diffusion media layer and an anode catalyst layer, wherein the anode diffusion media layer includes a blocking agent formed within side edges of the anode diffusion media layer a distance so that the blocking agent extends within outside edges of the anode catalyst layer;
a cathode side including a cathode diffusion media layer and a cathode catalyst layer, wherein the cathode diffusion media layer includes a blocking agent formed within side edges of the cathode diffusion media layer a distance so that the blocking agent extends within an outside edge of the cathode catalyst layer; and
a membrane positioned between and in contact with the anode catalyst layer and the cathode catalyst layer.

11. The fuel cell according to claim 10 wherein the blocking agent formed in the anode diffusion media layer is provided through the entire thickness of the anode diffusion media layer and the blocking agent formed in the cathode diffusion media layer is provided through the entire thickness of the cathode diffusion media layer.

12. The fuel cell according to claim 10 wherein the blocking agent formed in the anode diffusion media layer is provided through only a portion of the thickness of the anode diffusion media layer and the blocking agent formed in the cathode diffusion media layer is provided through only a portion of the thickness of the cathode diffusion media layer.

13. The fuel cell according to claim 10 wherein the blocking agents are uniformly dispersed throughout the anode and cathode diffusion media layers.

14. The fuel cell according to claim 10 wherein the blocking agent is a thermoplastic polymer.

15. The fuel cell according to claim 14 wherein the blocking agent is selected from the group consisting of polyvinylidene fluoride, polyaryl and polyethylene.

16. The fuel cell according to claim 10 wherein the fuel cell is part of a fuel cell stack.

17. The fuel cell according to claim 16 where the fuel cell stack is on a vehicle.

18. A method of making a fuel cell, said method comprising:
providing an anode diffusion media layer;
providing an anode catalyst layer;
providing a cathode diffusion media layer;
providing a cathode catalyst layer;
depositing a blocking agent within one or both of the anode diffusion media layer or the cathode diffusion media layer so that the blocking agent extends within outside edges of the anode catalyst layer and/or the cathode catalyst layer, wherein the blocking agent prevents or restricts gases that flow through the diffusion media layers from flowing to the membrane without first flowing to the catalyst layers; and
providing a membrane between and in contact with the anode catalyst layer and the cathode catalyst layer.

19. The method according to claim 18 wherein depositing a blocking agent includes depositing a blocking agent uniformly throughout the anode and/or cathode diffusion media layers.

20. The method according to claim 18 wherein depositing a blocking agent includes depositing a blocking agent in the anode diffusion media layer through the entire thickness of the anode diffusion media layer and/or depositing a blocking agent in the cathode diffusion media layer through the entire thickness of the cathode diffusion media layer.

21. The method according to claim 18 wherein depositing a blocking agent includes depositing a blocking agent in the anode diffusion media layer through only a portion of the thickness of the anode diffusion media layer and/or depositing a blocking agent in the cathode diffusion media layer through only a portion of the thickness of the cathode diffusion media layer.

22. The method according to claim 18 wherein depositing a blocking agent includes melting the blocking agent, flowing the blocking agent into the anode and/or cathode diffusion media layers, and hardening the blocking agent within the anode and/or cathode diffusion media layers.

23. The method according to claim 18 wherein depositing a blocking agent includes depositing a thermoplastic polymer.

24. The method according to claim 23 wherein depositing a blocking agent includes depositing a blocking agent selected from the group consisting of polyvinylidene fluoride, polyaryl and polyethylene.
